(19) United States
(12) Patent Application Publication
(10) Pub. No.: US 2026/0163494 A1
(43) Pub. Date: Jun. 11, 2026

(54) CONTROL METHOD FOR THREE-PHASE RECTIFIER AND POWER CONVERSION MODULE

(71) Applicant: Delta Electronics (Shanghai) CO., LTD., Shanghai (CN)

(72) Inventors: Yingqi ZHANG, Shanghai (CN); Shiyong NI, Shanghai (CN); Yanling ZONG, Shanghai (CN); Linchun LI, Shanghai (CN)

(73) Assignee: Delta Electronics (Shanghai) CO., LTD., Shanghai (CN)

(21) Appl. No.: 19/180,197

(22) Filed: Apr. 16, 2025

(30) Foreign Application Priority Data
Apr. 22, 2024 (CN) 2024104890294

(51) Int. Cl. H02M 7/217

(52) U.S. Cl. CPC H02M 7/2173

(57) ABSTRACT

Disclosed are a control method for a three-phase rectifier and a power conversion module. The control method includes: determining three-phase sinusoidal current reference signals according to an input voltage of the three-phase rectifier, a voltage of a first capacitor of the DC bus, and a voltage of a second capacitor of the DC bus; determining a common mode signal according to the voltage of the first capacitor and the voltage of the second capacitor; and determining, according to the sinusoidal current reference signal of any phase in the three-phase sinusoidal current reference signals, a carrier signal, the common mode signal and an input current of a corresponding phase, a gate signal of the corresponding phase, where the gate signal of the corresponding phase is configured to control an on or off of the switch unit of the corresponding phase.

### CROSS REFERENCE

This application is based upon and claims priority to Chinese Patent Application No. 2024104890294, filed on Apr. 22, 2024, the entire contents thereof are incorporated herein by reference.

### TECHNICAL FIELD

The present disclosure relates to the technical field of rectifiers, and particularly, to a control method for a three-phase rectifier and a power conversion module.

### BACKGROUND

When a Vienna rectifier is working, it is necessary to control the switch device to make the alternating current (AC) input current to be a sine wave, so as to meet the low harmonic requirement of the power grid side. Meanwhile, it is necessary to control the voltages of two capacitors connected in series on the direct current (DC) side to balance the voltages of the two capacitors, so as to ensure that the voltage stress of the switch device and the capacitors is within a safe range. However, when the grid voltage is distorted or is unbalanced, harmonics or distortion may occur in the input current. In this case, if the input current is adjusted to keep it as a sine wave, the harmonic sub-current needs to be controlled, which not only significantly increases the amount of calculation, but also increases the difficulty of controlling the rectifier.

It should be noted that the information disclosed in the above background is only used to enhance an understanding of the background of the present disclosure, therefore it may include information that does not constitute the prior art known to those skilled in the art.

### SUMMARY

Other features and advantages of the present disclosure will become apparent through the following detailed description, or, may be learned partially by practice of the present disclosure.

According to a first aspect of the present disclosure, a control method for a three-phase rectifier is provided, where the three-phase rectifier includes a DC bus and a three-phase switch unit, the DC bus is electrically connected to the three-phase switch unit, and the control method includes following steps:
step S1: determining three-phase sinusoidal current reference signals according to an input voltage of the three-phase rectifier, a voltage of a first capacitor of the DC bus, and a voltage of a second capacitor of the DC bus;
step S2: determining a common mode signal according to the voltage of the first capacitor and the voltage of the second capacitor; and
step S3: determining, according to the sinusoidal current reference signal of any phase in the three-phase sinusoidal current reference signals, a carrier signal, the common mode signal and an input current of a corresponding phase, a gate signal of the corresponding phase, where the gate signal of the corresponding phase is configured to control the on or off of the switch unit of the corresponding phase.

According to a second aspect of the present disclosure, a power conversion module is further provided, where the power conversion module includes:
a three-phase rectifier, where the three-phase rectifier includes a DC bus and a three-phase switch unit, where the DC bus is electrically connected to the three-phase switch unit; and
a controller, where the controller is configured to:
determine three-phase sinusoidal current reference signals according to an input voltage of the three-phase rectifier, a voltage of a first capacitor of the DC bus, and a voltage of a second capacitor of the DC bus;
determine a common mode signal according to the voltage of the first capacitor and the voltage of the second capacitor; and
determine, according to the sinusoidal current reference signal of any phase in the three-phase sinusoidal current reference signals, a carrier signal, the common mode signal and an input current of a corresponding phase, a gate signal of the corresponding phase, where the gate signal of the corresponding phase is configured to control the on or off of the switch unit of the corresponding phase.

It should be understood that the foregoing general description and the following detailed description are exemplary and explanatory only, and do not limit the present disclosure.

### BRIEF DESCRIPTION OF THE DRAWINGS

The accompanying drawings herein, which are incorporated in and constitute a part of this specification, illustrate embodiments consistent with the present disclosure and are used in conjunction with the specification to explain the principles of the present disclosure. Obviously, the drawings in the following description are only some embodiments of the present disclosure. For those of ordinary skill in the art, other drawings can also be obtained from these drawings without paying creative effort.

FIG. 1 shows a schematic diagram of a simplified structure of a three-phase rectifier in an embodiment of the present disclosure;

FIG. 2 shows a schematic diagram of a control method for a three-phase rectifier in an embodiment of the present disclosure;

FIG. 3 shows a schematic diagram of an implementation process of step S1 in some embodiments of the present disclosure;

FIG. 4 shows a schematic diagram of an implementation process of step S11 in some embodiments of the present disclosure;

FIG. 5 shows a control block diagram for determining the angle θ in some specific embodiments of the present disclosure;

FIG. 6 shows a schematic diagram of an implementation process of step S13 in some embodiments of the present disclosure;

FIG. 7 shows a schematic diagram of an implementation process of step S2 in some embodiments of the present disclosure;

FIG. 8 shows a schematic diagram of an implementation process of step S3 in some embodiments of the present disclosure;

FIG. 9 shows a block diagram of an instantaneous current inner loop control of a three-phase Vienna rectifier of a specific example in the present disclosure;

FIG. 10 shows a control block diagram for three-phase sinusoidal signals of a specific example in the present disclosure;

FIG. 11 shows a control block diagram for three-phase sinusoidal current reference signals of a specific example in the present disclosure;

FIG. 12 shows a control block diagram for generating a common mode signal through an equalizer ring of a specific example in the present disclosure;

FIG. 13 shows a schematic diagram of a control waveform of a specific example in the present disclosure; and

FIG. 14 shows a schematic diagram of a simplified structure of a power conversion module in some embodiments of the present disclosure.

### DETAILED DESCRIPTION

Exemplary embodiments will now be described more fully with reference to the accompanying drawings. Exemplary embodiments may, however, be embodied in various forms and should not be construed as limited to the examples set forth herein. Rather, these embodiments are provided so that the present disclosure will be more thorough and complete, and the ideas of the exemplary embodiments will be fully conveyed to those skilled in the art. The described features, structures, or characteristics may be combined in any suitable manner in one or more embodiments.

In addition, the accompanying drawings are only schematic illustrations of the present disclosure and are not necessarily drawn to scale. In the accompanying drawings, the same reference sign indicates the same or similar part, and repeated descriptions thereof will be omitted. Some of the block diagrams shown in the accompanying drawings are functional entities and do not necessarily correspond to physically or logically separate entities. These functional entities may be implemented in software form, or in one or more hardware modules or integrated circuits, or in different networks and/or processor apparatuses and/or microcontroller apparatuses.

The specific implementations of the embodiments of the present disclosure are described in detail below with reference to the accompanying drawings.

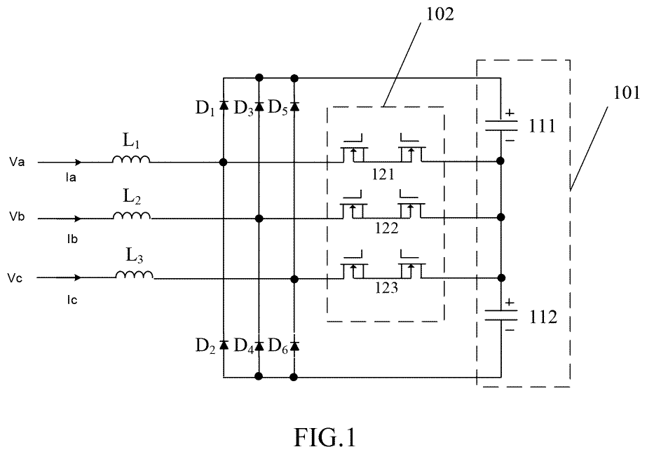

As shown in FIG. 1, a three-phase rectifier provided in an embodiment of the present disclosure includes: a DC bus 101 and a three-phase switch unit 102, where the DC bus 101 is electrically connected to the three-phase switch unit 102. Specifically, the three-phase switch unit 102 includes a switch unit of a first phase 121, a switch unit of a second phase 122, and a switch unit of a third phase 123. It should be noted that the three-phase switch unit 102 is electrically connected to the three-phase alternating current on the grid side, that is, the switch unit of the first phase 121, the switch unit of the second phase 122, and the switch unit of the third phase 123 are electrically connected to an alternating current of phase a, an alternating current of phase b, and an alternating current of phase c, respectively, in one-to-one correspondence. It may be understood by those skilled in the art that the connection relationship is not fixed, as long as a switch unit of one phase is connected to an alternating current of one phase, that is, the switch unit of the first phase 121 may be electrically connected to the alternating current of phase a, may be electrically connected to the alternating current of phase b, and may also be electrically connected to the alternating current of phase c, and the embodiments of the present disclosure are not limited thereto.

In a specific implementation, as shown in FIG. 1, the DC bus 101 includes a first capacitor 111 and a second capacitor 112, and the first capacitor 111 and the second capacitor 112 are connected in series on the DC side. In some embodiments of the present disclosure, the three-phase rectifier includes a Vienna rectifier, that is, the three-phase rectifier may be a Vienna rectifier of various connection forms, which is a pulse width modulated rectifier that may receive a three-phase AC power supply, and is also a power factor correction circuit. Specifically, as shown in FIG. 1, the Vienna rectifier further includes: a first inductor L₁, a second inductor L₂, a third inductor L₃, a first diode D₁, a second diode D₂, a third diode D₃, a fourth diode D₄, a fifth diode D₅, and a sixth diode D₆. Taking the alternating current input of phase a as an example, after the alternating current of phase a is input through the first inductor L₁, when the switch unit of the first phase 121 is in the on state, when the alternating current of phase a is in a positive half cycle, it flows through the circuit formed by the first diode D₁ and the first capacitor 111; when the alternating current of phase a is in a negative half cycle, it flows through the circuit formed by the second diode D₂ and the second capacitor 112. It may be understood by those skilled in the art that the Vienna rectifier shown in FIG. 1 is only an example of one connection manner in a specific embodiment of the present disclosure, and Vienna rectifiers with different connection manners may be used according to actual needs, and the present disclosure is not limited thereto.

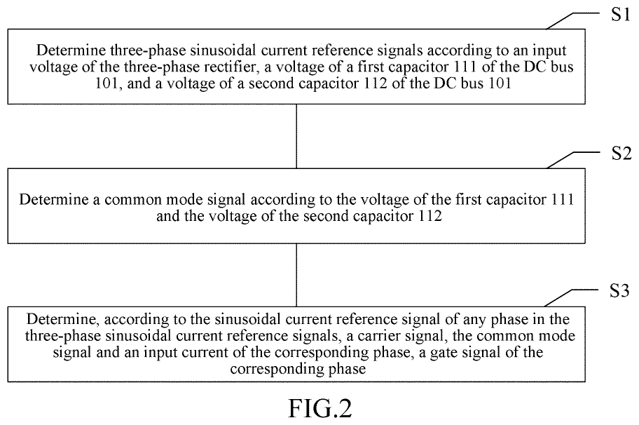

For the above three-phase rectifier, an embodiment of the present disclosure provides a control method, as shown in FIG. 2, the method includes the following steps.

In step S1, three-phase sinusoidal current reference signals are determined according to an input voltage of the three-phase rectifier, a voltage of a first capacitor 111 of the DC bus 101, and a voltage of a second capacitor 112 of the DC bus 101.

It should be noted that the three-phase sinusoidal current reference signals are determined reference values of the three-phase AC input current, so that when the three-phase AC input current is adjusted, the three-phase sinusoidal current reference signals are used as references for regulation, thereby avoiding interference with the regulation brought about by harmonics or distortion of the AC voltage.

In step S2, a common mode signal is determined according to the voltage of the first capacitor 111 and the voltage of the second capacitor 112.

In step S3, according to the sinusoidal current reference signal of any phase in the three-phase sinusoidal current reference signals, a carrier signal, the common mode signal and an input current of the corresponding phase, a gate signal of the corresponding phase is determined.

It should be noted that the gate signal of the corresponding phase is used to control the on or off of the switch unit of the corresponding phase. Through the state change of the switch unit, the AC input current of the corresponding phase is adjusted to maintain a sinusoidal waveform.

As can be seen from the above steps, in the control method for the three-phase rectifier provided in the embodiments of the present disclosure, through determining the three-phase sinusoidal current reference signals by using an input voltage of the three-phase rectifier, a voltage of a first capacitor of the DC bus, and a voltage of a second capacitor of the DC bus, and determining, by using the sinusoidal current reference signal of any phase in the three-phase sinusoidal current reference signals, a carrier signal, a common mode signal and an input current of the corresponding phase, a gate signal of the corresponding phase, the on or off of the switch unit of the corresponding phase is controlled so as to adjust the AC input current to maintain a sine wave. By determining the three-phase sinusoidal current reference signals and taking the three-phase sinusoidal current reference signals as the reference during control, it makes the adjustment of the AC input current follow the current reference signal instead of the voltage signal, so that when the grid voltage is distorted or is unbalanced, the control of the AC input current is not affected, thus no harmonic or distorted input current will appear, thereby reducing the amount of calculation required for control and the difficulty of controlling the rectifier.

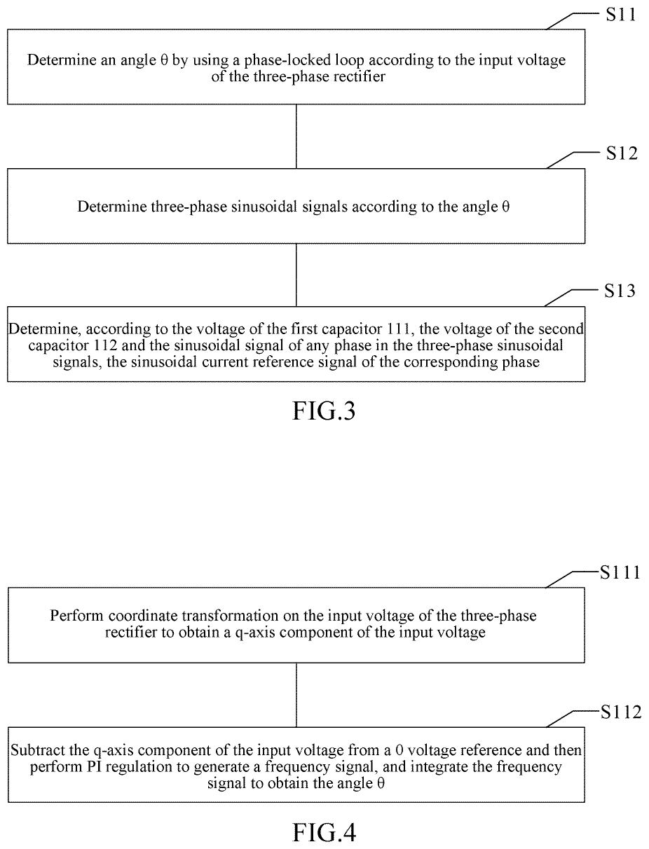

In some embodiments of the present disclosure, the specific implementation process of the step S1 is shown in FIG. 3 and includes the following steps.

In step S11, an angle θ is determined by using a phase-locked loop according to the input voltage of the three-phase rectifier.

It should be noted that the phase-locked loop is implemented by software and is a three-phase phase-locked loop based on dq synchronous rotating coordinate transformation. The rotating coordinate transformation plays a role in phase detection and obtains the q-axis component of the three-phase voltage to obtain phase information. The output of a PI controller serves as the angular frequency, and after being passed through the integrator, a phase-locked voltage phase is output.

In step S12, three-phase sinusoidal signals are determined according to the angle θ.

It should be noted that the three-phase sinusoidal signals include a sinusoidal signal of a first phase, a sinusoidal signal of a second phase and a sinusoidal signal of a third phase; where the sinusoidal signal of the first phase is sinθ; the sinusoidal signal of the second phase is sin(θ−120°); and the sinusoidal signal of the third phase is sin(θ+120°). It may be understood by those skilled in the art that the sinusoidal signal of the first phase may also be sin(θ−120°) or sin(θ+120°), and the sinusoidal signals of the remaining two phases only need to have a phase difference of 120 degrees with the sinusoidal signal of the first phase, which will not be described in detail in the embodiments of the present disclosure.

In step S13, according to the voltage of the first capacitor 111, the voltage of the second capacitor 112 and the sinusoidal signal of any phase in the three-phase sinusoidal signals, the sinusoidal current reference signal of the corresponding phase is determined.

In some embodiments of the present disclosure, the specific implementation process of S11 is shown in FIG. 4 and includes the following steps.

In step S111, abc/dq coordinate transformation is performed on the input voltage of the three-phase rectifier to obtain a q-axis component of the input voltage.

It should be noted that the coordinate transformation is performed on the input voltage of the three-phase rectifier to transform from the three-phase stationary abc coordinate system to the dq rotating coordinate system, and Park's transformation is performed to obtain the q-axis component of the input voltage after the three-phase input voltage is transformed. When S11 is specifically implemented, the abc/dq coordinate transformation is performed by using the angle θ.

In step S112, the q-axis component of the input voltage is subtracted from a 0 voltage reference and PI regulation is then performed to generate a frequency signal, and the frequency signal is integrated to obtain the angle θ.

It should be noted that the q-axis component of the transformed input voltage is a reactive component of the transformed input voltage. The most ideal state is that the reactive component of the input voltage is 0. Therefore, the q-axis component of the input voltage is subtracted from the 0 voltage reference to serve as an error amount of the PI regulation to perform the adjustment, and through the adjustment, the frequency signal is obtained.

In order to better illustrate the specific implementation process of the step S11, FIG. 5 shows a control block diagram of how to determine the angle θ using a phase-locked loop in a specific embodiment of the present disclosure. The input terminals are the instantaneous values Va, Vb, Vc of three-phase AC input voltages in the three-phase stationary abc coordinate system, and after abc/dq transformation (Park' transformation) is performed, the d-axis component Vd of the input voltage and the q-axis component Vq of the input voltage are output. The transformed Vd is: Vd=k×V×cos(ωt−θ), and the transformed Vq is: Vq=k×V×sin(ωt−θ).

In the above, k represents a coefficient; V represents the amplitude of the voltage; ω represents the angular frequency; t represents the time; and θ represents the angle.

When the phase-locked loop is operating, the control target is to make the difference between Vq and 0 to be equal to 0, that is, to make Vq close to the 0 voltage reference. In this case, sin(ωt−θ)=0, that is, the final control target of ωt is equal to θ. Based on this control target, the PI controller is used for control to obtain the angular frequency ω of the input voltage. The angular frequency ω of the input voltage is then input into the integrator for performing integration, to obtain a periodic angle θ ranging from 0 degree to 360 degrees. The angle θ obtained by integration is further fed back to the Park's transformation.

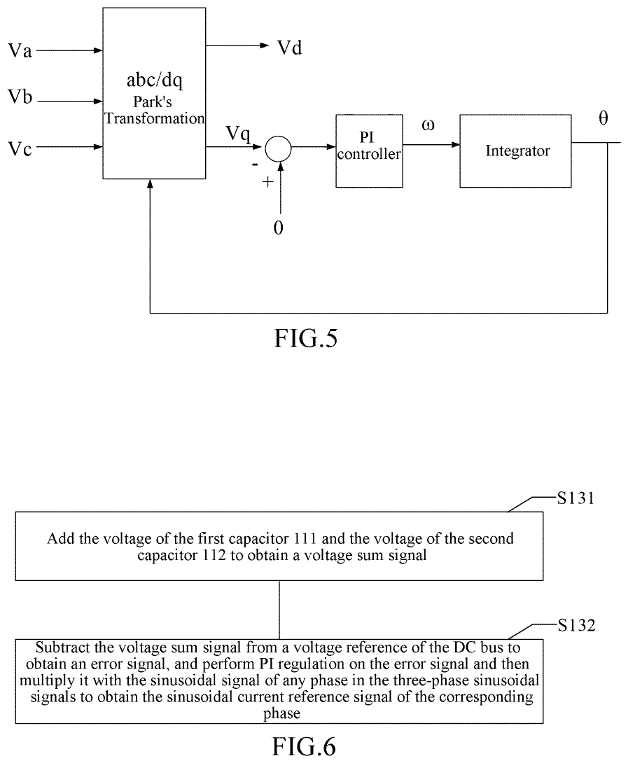

In some embodiments of the present disclosure, the specific implementation process of the step S13 is shown in FIG. 6 and includes the following steps.

In step S131, the voltage of the first capacitor 111 and the voltage of the second capacitor 112 are added to obtain a voltage sum signal.

In step S132, the voltage sum signal is subtracted from a voltage reference of the DC bus to obtain an error signal, and PI regulation is performed on the error signal and then it is multiplied with the sinusoidal signal of any phase in the three-phase sinusoidal signals to obtain the sinusoidal current reference signal of the corresponding phase.

It should be noted that the first capacitor 111 and the second capacitor 112 in the DC bus 101 are connected in series, and a real-time value of the voltage of the first capacitor 111 and a real-time value of the voltage of the second capacitor 112 are added to form a real-time value of the voltage of the DC bus 101. When the three-phase rectifier is operating, the voltage of the DC bus 101 will have a reference value. The voltage sum signal is subtracted from the voltage reference of the DC bus 101 to obtain an error signal, which is an amount of regulation required by the voltage of the DC bus 101. After inputting the error signal into the PI controller, a calibration amount of the voltage of the DC bus 101 may be obtained. The calibration amount of the voltage of the DC bus 101 is multiplied by the sinusoidal signal of any phase in the three-phase sinusoidal signals to obtain a calibration amount of the sinusoidal current of the corresponding phase. That is, the voltage error is fed back to the current signal, so as to obtain the sinusoidal current reference signal of the corresponding phase as the reference when the input current is regulated.

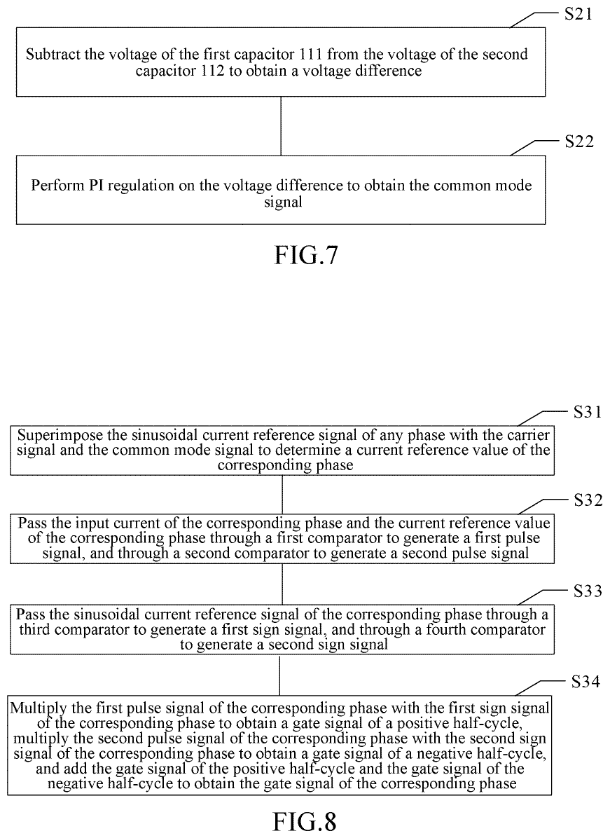

In some embodiments of the present disclosure, the specific implementation process of the step S2 is shown in FIG. 7 and includes the following steps.

In step S21, the voltage of the first capacitor 111 is subtracted from the voltage of the second capacitor 112 to obtain a voltage difference.

In step S22, PI regulation is performed on the voltage difference to obtain the common mode signal.

It should be noted that when the three-phase rectifier is operating, it is also necessary to ensure the voltage balance between the first capacitor 111 and the second capacitor 112, that is, the ideal state of the voltage difference between the two is 0. The voltage difference is used as an amount of control of PI regulation, and the voltage difference approaching 0 is used as the control target. PI regulation is performed to obtain an amount of voltage feedback, which is used as a common mode signal and superimposed on the input of each phase to achieve voltage balancing on the DC bus 101 side.

In some embodiments of the present disclosure, the specific implementation process of the step S3 is shown in FIG. 8 and includes the following steps.

In step S31, the sinusoidal current reference signal of any phase is superimposed with the carrier signal and the common mode signal to determine a current reference value of the corresponding phase.

It should be noted that the current reference value of the corresponding phase is based on the control target that the input current of the corresponding phase maintains a sinusoidal waveform, the voltage on the DC bus 101 side is the reference value, and the voltages of the two capacitors contained in the DC bus 101 are consistent. The ideal state of the current of the corresponding phase is the current reference value of the corresponding phase.

It should be noted that the frequency of the carrier signal is fixed, and may be a triangle wave or a sawtooth wave.

In step S32, the input current of the corresponding phase and the current reference value of the corresponding phase pass through a first comparator to generate a first pulse signal, and pass through a second comparator to generate a second pulse signal.

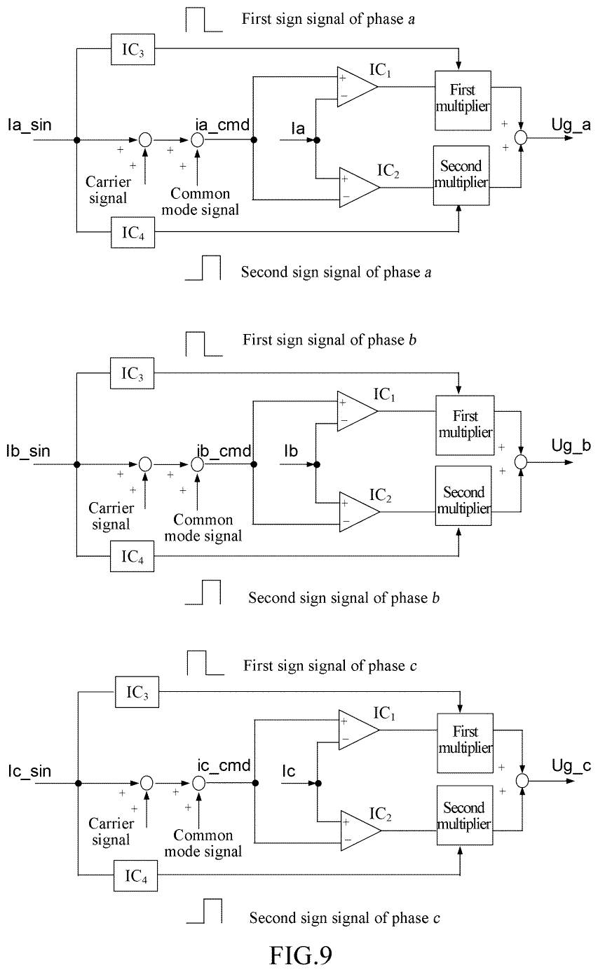

It should be noted that the first comparator generating the first pulse signal has a positive input terminal connected to the current reference value of the corresponding phase (such as ia_cmd in FIG. 9), and a negative input terminal connected to the input current of the corresponding phase (such as Ia in FIG. 9). The connecting manner of the second comparator generating the second pulse signal is different from that of the first comparator, where the positive input terminal of the second comparator is connected to the input current of the corresponding phase, and the negative input terminal is connected to the current reference value of the corresponding phase.

In step S33, the sinusoidal current reference signal of the corresponding phase passes through a third comparator to generate a first sign signal, and passes through a fourth comparator to generate a second sign signal.

In step S34, the first pulse signal of the corresponding phase is multiplied with the first sign signal to obtain a gate signal of a positive half-cycle, the second pulse signal of the corresponding phase is multiplied with the second sign signal to obtain a gate signal of a negative half-cycle, and the gate signal of the positive half-cycle is added to the gate signal of the negative half-cycle to obtain the gate signal of the corresponding phase.

It should be noted that when the sinusoidal current reference signal of the corresponding phase is a positive half-wave, the value of the first sign signal is 1, and the value of the second sign signal is 0; when the sinusoidal current reference signal of the corresponding phase is a negative half-wave, the value of the first sign signal is 0, and the value of the second sign signal is 1. In other words, the first pulse signal and the second pulse signal are multiplied by the signs of the positive and negative half-waves to obtain the gate signals of the positive and negative half-waves.

It should be noted that since the frequency of the carrier signal is fixed, the frequency of the obtained gate signal is also fixed, and the switching frequency of the switch unit controlled by the above gate signal is also fixed, which facilitates filtering, thereby bringing out a better harmonic filtered signal in the output of the three-phase rectifier.

It should be noted that the voltage and current mentioned in the embodiments of the present disclosure refer to their instantaneous values. The control is carried out by obtaining the instantaneous values of voltage and current to obtain the regulation strategy, so that the instantaneous value of the current at the next moment may approach to the reference value of the control.

In order to better illustrate the control method for the three-phase rectifier provided by the embodiments of the present disclosure, a specific example is now provided for further explanation. The specific example uses the control block diagrams shown in FIG. 9 to control the rectification of the three-phase Vienna rectifier. Specifically, three-phase control sub-block diagrams including phase a, phase b, and phase c are included, and the control sub-block diagram of phase a is taken as an example to illustrate the regulation process of the control sub-block diagram of each phase:

After the sinusoidal current reference signal Ia_sin of phase a is input, it is divided into two paths, one path is input into the third comparator IC₃ to generate the first sign signal of phase a, and the other path is input into the fourth comparator IC₄ to generate the second sign signal of phase a. When the sinusoidal current reference signal of phase a is a positive half-wave, the value of the first sign signal of phase a is 1, and the value of the second sign signal of phase a is 0; when the sinusoidal current reference signal of phase a is a negative half-wave, the value of the first sign signal of phase a is 0, and the value of the second sign signal of phase a is 1.

After the sinusoidal current reference signal of phase a is input, the carrier signal in a triangular wave form and the common mode signal are superimposed to obtain the current reference value ia_cmd of phase a, which is also divided into two paths, one of which is input into the positive phase input terminal of the first comparator IC₁, and the other is input into the inverted phase input terminal of the second comparator IC₂. The input current Ia of phase a is also divided into two paths, one of which is input into the inverted phase input terminal of the first comparator IC₁, and the other is input into the positive phase input terminal of the second comparator IC₂. The output terminal of the first comparator IC₁ outputs the first pulse signal of phase a, and the output terminal of the second comparator IC₂ outputs the second pulse signal of phase a.

The first sign signal of phase a and the first pulse signal of phase a are input into the first multiplier to output the gate signal of phase a in the positive half cycle. The second sign signal of phase a and the second pulse signal of phase a are input into the second multiplier to output the gate signal of phase a in the negative half cycle.

The gate signal of phase a in the positive half cycle is added to the gate signal of phase a in the negative half cycle to obtain the gate signal Ug_a of phase a.

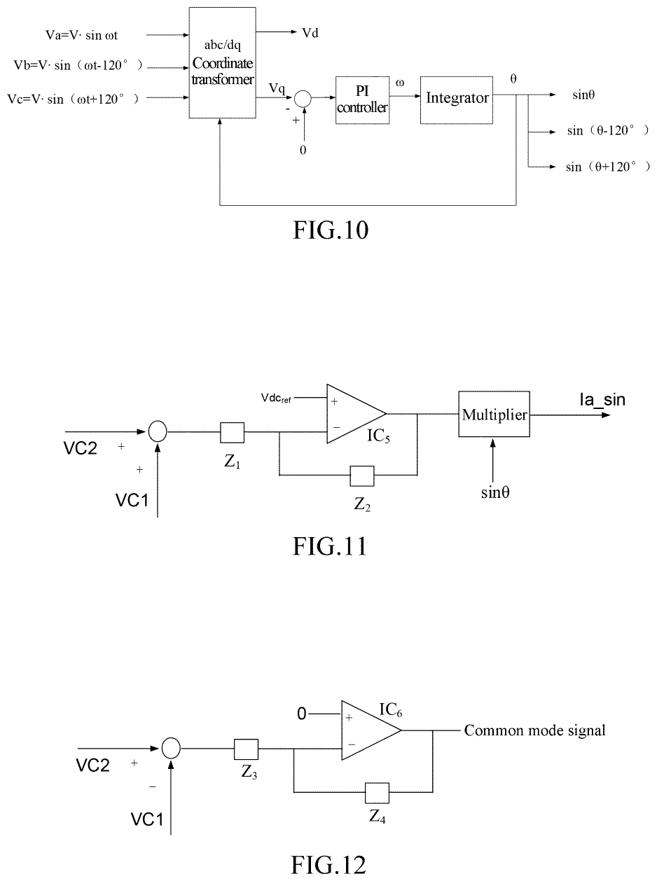

The process of determining the sinusoidal current reference signal Ia_sin of phase a is shown in FIG. 10 and FIG. 11.

As shown in FIG. 10, the input voltage of phase a is V·sin ωt, the input voltage of phase b is V·sin (ωt−120°), and the input voltage of phase c is V·sin (ωt+120°). They are input into the abc/dq coordinate transformer together, and Vq is output. After the difference between Vq and the 0 voltage reference is input into the PI controller, the adjustment result of ω is obtained. Then ω is input into the integrator for performing integration to obtain the angle θ, and the angle θ is further used in the coordinate transformation performed by the abc/dq coordinate transformer. After θ is obtained, sinθ is output as the sinusoidal signal of phase a, sin (θ−120°) is output as the sinusoidal signal of phase b, and sin (θ+120°) is output as the signal of phase c.

After the sinusoidal signal sinθ of phase a is obtained, it serves as an input and is input into the multiplier shown in FIG. 11. The sum of the first capacitor voltage VC1 and the second capacitor voltage VC2, that is, the voltage sum signal, serves as an input and is input into the inverted phase input terminal of the fifth comparator IC₅ after passing through the first impedance Z₁, the voltage reference Vdc_{ref} of the DC bus is input into the positive phase input terminal of the fifth comparator IC₅, and the second impedance Z₂ is connected in series between the inverted phase input terminal and the output terminal of the fifth comparator IC₅. The output signal of the output terminal of the fifth comparator IC₅ serves as the other input of the multiplier as shown in FIG. 11, so that the multiplier shown in FIG. 11 outputs the sinusoidal current reference signal Ia_sin of phase a. Those skilled in the art may understand that by replacing the sinusoidal signal sinθ of phase a with a sinusoidal signal sin(θ−120°) of phase b, the sinusoidal current reference signal Ib_sin of phase b may be output, and by replacing the sinusoidal signal sinθ of phase a with a sinusoidal signal sin(θ+120°) of phase c, the sinusoidal current reference signal Ic_sin of phase c may be output. In specific implementation, two more paths may be set, each of which is similar to the circuit connection shown in FIG. 11, except that one input of the multiplier is adaptively changed to the sinusoidal signal sin (θ−120°) of phase b or the sinusoidal signal sin (θ+120°) of phase c. Two additional multipliers may also be added on the basis of the circuit shown in FIG. 11, one input of each multiplier is connected to the output signal of the output terminal of the fifth comparator IC₅, the other input of the second multiplier is connected to the sinusoidal signal sin (θ−120°) of phase b, and the other input of the third multiplier is connected to the sinusoidal signal sin (θ+120°) of phase c. By sharing the first impedance Z₁, the second impedance Z₂ and the fifth comparator IC₅, fewer components are used, and the investment cost is further reduced.

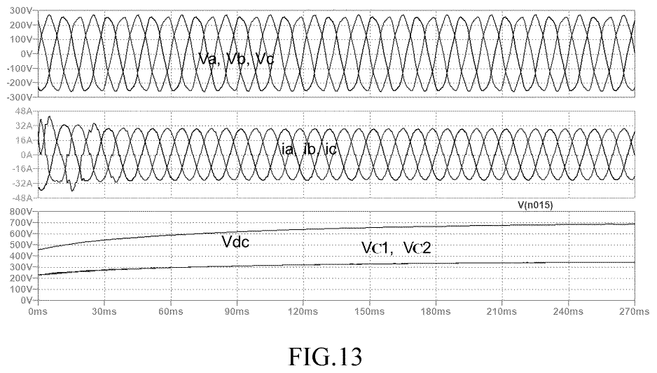

The above process of generating the common mode signal through an equalizer ring is shown in FIG. 12. The difference between the first capacitor voltage VC1 and the second capacitor voltage VC2, that is, the voltage difference signal serves as an input and is input to the inverted phase input terminal of a sixth comparator IC₆ after passing through a third impedance Z₃. The ideal value 0 of the voltage difference is input to the positive phase input terminal of the sixth comparator IC₆, and a fourth impedance Z₄ is connected in series between the inverted phase input terminal and the output terminal of the sixth comparator IC₆, and the common mode signal is output from the output terminal of the sixth comparator IC₆.

Specifically, the above carrier signal is in the form of a triangular wave, which may make the triangular wave serve as a window, and the sinusoidal current reference signal of phase a and the common mode signal are superimposed and then intersect with the triangular wave, thereby generating the gate signal.

FIG. 13 shows the waveforms of changes of the three-phase input voltages Va, Vb, Vc, the three-phase input currents Ia, Ib, Ic, the DC bus voltages Vdc, the voltage VC1 of the first capacitor 111 and the voltage VC2 of the second capacitor 112 over time after being regulated by the three-phase Vienna rectifier using the control block diagrams shown in FIGS. 9 to 12 in this specific example. It may be seen from FIG. 13 that the waveforms of the three-phase input voltages are not smooth. When the three-phase input voltages are distorted (the top and bottom of the waveform in the figure are sharp), the three-phase input currents still maintain sine waves without distortion, the waveforms of the voltage VC1 of the first capacitor 111 and the voltage VC2 of the second capacitor 112 coincide, and the DC bus voltage Vdc is also smooth. It can be seen that the voltage at the DC bus side meets the requirements and the voltages of the capacitors at the DC bus side are balanced.

It may be seen from the above specific example that, when regulating the three-phase input currents in this specific example, the instantaneous values of the input currents are tracked, the three-phase sinusoidal current reference signal, the triangular carrier signal and the common mode signal output by the voltage averaging control of the voltages of the capacitors at the DC bus side are added to obtain the per-phase sinusoidal reference value of the input current, which is then compared with the input current of each phase to generate a modulation signal to control the switch unit of each phase.

As a result, the input current of the Vienna rectifier is directly controlled in each switching cycle. When the input current is less than the corresponding reference value, the gate signal controls the switch unit to be turned on and the input current increases; when the current reaches the corresponding reference value, the gate signal controls the switch unit to be turned off and the input current decreases; and when the input current is less than the corresponding reference value, the gate signal controls the switch unit to be turned on. As a result, when the grid voltage is distorted, the instantaneous value of the input current tracks the sinusoidal reference of the current, so that the input current obtained by regulation will not be distorted.

Based on the same inventive concept, a power conversion module is further provided in an embodiment of the present disclosure, as described in the following embodiment. Since the principle of solving the problem in the embodiment of power conversion module is similar to that in the above method embodiment, the implementation of the power conversion module embodiment may refer to the implementation of the above method embodiment, and the repetition will not be described in detail.

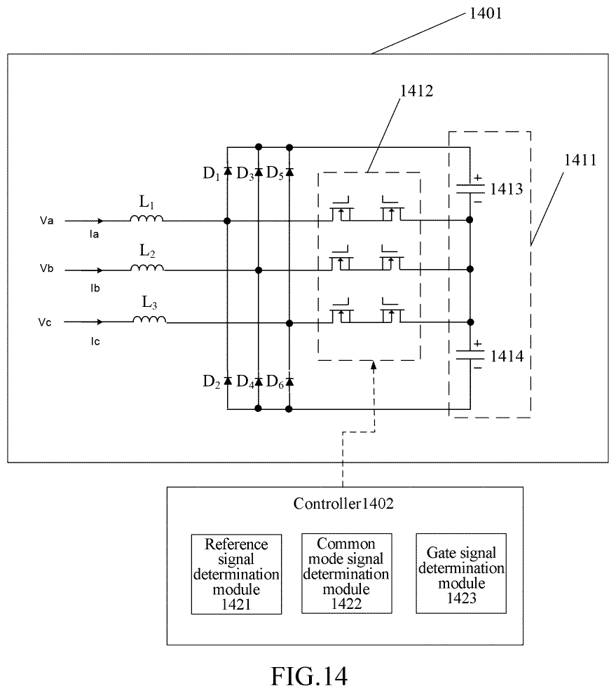

FIG. 14 shows a simplified structural diagram of a power conversion module in an embodiment of the present disclosure, as shown in FIG. 14, the module includes:
a three-phase rectifier 1401, where the three-phase rectifier includes a DC bus 1411 and a three-phase switch unit 1412, and the DC bus 1411 is electrically connected to the three-phase switch unit 1412; and
a controller 1402, where the controller 1402 is configured to:
determine three-phase sinusoidal current reference signals according to an input voltage of the three-phase rectifier 1401, a voltage of a first capacitor 1413 of the DC bus 1411, and a voltage of a second capacitor 1414 of the DC bus 1411;
determine a common mode signal according to the voltage of the first capacitor 1413 and the voltage of the second capacitor 1414; and
determine, according to the sinusoidal current reference signal of any phase in the three-phase sinusoidal current reference signals, a carrier signal, the common mode signal and an input current of the corresponding phase, a gate signal of the corresponding phase, where the gate signal of the corresponding phase is used to control the on or off of the switch unit of the corresponding phase.

It should be noted that the three-phase rectifier 1401 includes a Vienna rectifier.

In some embodiments of the present disclosure, the controller 1402 includes: a reference signal determination module 1421, and the reference signal determination module 1421 is configured to:
determine an angle θ by using a phase-locked loop according to the input voltage of the three-phase rectifier;
determine three-phase sinusoidal signals according to the angle θ; and
determine, according to the voltage of the first capacitor 1413, the voltage of the second capacitor 1414 and the sinusoidal signal of any phase in the three-phase sinusoidal signals, the sinusoidal current reference signal of the corresponding phase.

In some embodiments of the present disclosure, the reference signal determination module 1421 is specifically configured to:
perform abc/dq coordinate transformation on the input voltage of the three-phase rectifier 1401 to obtain a q-axis component of the input voltage; and
subtract the q-axis component of the input voltage from a 0 voltage reference and then perform PI regulation to generate a frequency signal, and integrate the frequency signal to obtain the angle θ.

In some embodiments of the present disclosure, the reference signal determination module 1421 is specifically configured to:
perform abc/dq coordinate transformation by using the angle θ.

In some embodiments of the present disclosure, the reference signal determination module 1421 is specifically configured to:
add the voltage of the first capacitor 1413 and the voltage of the second capacitor 1414 to obtain a voltage sum signal; and
subtract the voltage sum signal from a voltage reference of the DC bus 1411 to obtain an error signal, and perform PI regulation on the error signal and then multiply it with the sinusoidal signal of any phase in the three-phase sinusoidal signals to obtain the sinusoidal current reference signal of the corresponding phase.

In some embodiments of the present disclosure, the three-phase sinusoidal signals include a sinusoidal signal of a first phase, a sinusoidal signal of a second phase and a sinusoidal signal of a third phase; where the sinusoidal signal of the first phase is sin θ; the sinusoidal signal of the second phase is sin(θ−120°); and the sinusoidal signal of the third phase is sin(θ+120°).

In some embodiments of the present disclosure, the controller 1402 includes: a common mode signal determination module 1422, and the common mode signal determination module 1422 is configured to:
subtract the voltage of the first capacitor 1413 from the voltage of the second capacitor 1414 to obtain a voltage difference; and
perform proportional-integral (PI) regulation on the voltage difference to obtain the common mode signal.

In some embodiments of the present disclosure, the controller 1402 includes: a gate signal determination module 1423, and the gate signal determination module 1423 is configured to:
superimpose the sinusoidal current reference signal of any phase with the carrier signal and the common mode signal to determine a current reference value of the corresponding phase;
pass the input current of the corresponding phase and the current reference value of the corresponding phase through a first comparator to generate a first pulse signal, and through a second comparator to generate a second pulse signal;
pass the sinusoidal current reference signal of the corresponding phase through a third comparator to generate a first sign signal, and through a fourth comparator to generate a second sign signal; and
multiply the first pulse signal of the corresponding phase with the first sign signal to obtain a gate signal of a positive half-cycle, multiply the second pulse signal of the corresponding phase with the second sign signal to obtain a gate signal of a negative half-cycle, and add the gate signal of the positive half-cycle and the gate signal of the negative half-cycle to obtain the gate signal of the corresponding phase.

In some embodiments of the present disclosure, when the sinusoidal current reference signal of the corresponding phase is a positive half-wave, a value of the first sign signal is 1 and a value of the second sign signal is 0; when the sinusoidal current reference signal of the corresponding phase is a negative half-wave, the value of the first sign signal is 0 and the value of the second sign signal is 1.

It will be appreciated by those skilled in the art that various aspects of the present disclosure may be implemented as systems, methods or program products. Therefore, various aspects of the present disclosure may be specifically implemented in the following forms, i.e., a complete hardware implementation, a complete software implementation (including firmware, microcode, etc.), or an implementation combining hardware and software aspects, which may be collectively referred to herein as a “circuit”, “module” or “system”. It should be noted that although several modules or units of a device for action execution are mentioned in the above detailed description, such division is not mandatory. In fact, according to the implementations of the present disclosure, the features and functions of two or more modules or units described above may be embodied in one module or unit. Conversely, the features and functions of one module or unit described above may be further divided to be embodied by multiple modules or units.

Furthermore, although various steps of the methods of the present disclosure are depicted in the drawings in a specific order, it does not require or imply that the steps must be performed in that specific order, or that all of the illustrated steps must be performed to achieve the desired results. Additionally or alternatively, certain steps may be omitted, multiple steps may be combined into one step for execution, and/or one step may be decomposed into multiple steps for execution, etc.

Through the description of the above implementations, those skilled in the art may easily understand that the exemplary implementations described here may be implemented by software or by software combined with necessary hardware(s). Therefore, the technical solutions according to the implementations of the present disclosure may be embodied in the form of a software product that may be stored in a non-volatile storage medium (which may be a CD-ROM, a USB flash drive, a mobile hard disk, etc.) or on a network, and the software product includes several instructions to cause a computing device (which may be a personal computer, a server, a mobile terminal, a network device, etc.) to execute the method according to the implementations of the present disclosure.

Other implementation solutions of the present disclosure will be readily apparent to those skilled in the art upon consideration of the specification and practice of the present disclosure disclosed herein. The present disclosure is intended to cover any variations, uses, or adaptations of the present disclosure that follow the general principles of the present disclosure and include common knowledge or customary technical means in the technical field that are not disclosed in the present disclosure. The specification and embodiments are to be considered as exemplary only, and the true scope and spirit of the present disclosure are indicated by the appended claims.

What is claimed is:

1. A control method for a three-phase rectifier, wherein the three-phase rectifier comprises a DC bus and a three-phase switch unit, wherein the DC bus is electrically connected to the three-phase switch unit, and wherein the control method comprises following steps:
step S1: determining three-phase sinusoidal current reference signals according to an input voltage of the three-phase rectifier, a voltage of a first capacitor of the DC bus, and a voltage of a second capacitor of the DC bus;
step S2: determining a common mode signal according to the voltage of the first capacitor and the voltage of the second capacitor; and
step S3: determining, according to the sinusoidal current reference signal of any phase in the three-phase sinusoidal current reference signals, a carrier signal, the common mode signal and an input current of a corresponding phase, a gate signal of the corresponding phase, wherein the gate signal of the corresponding phase is configured to control an on or off of the switch unit of the corresponding phase.

2. The control method according to claim 1, wherein the step S1 specifically comprises:
step S11: determining an angle θ by using a phase-locked loop according to the input voltage of the three-phase rectifier;
step S12: determining three-phase sinusoidal signals according to the angle θ; and
step S13: determining, according to the voltage of the first capacitor, the voltage of the second capacitor and the sinusoidal signal of any phase in the three-phase sinusoidal signals, the sinusoidal current reference signal of the corresponding phase.

3. The control method according to claim 1, wherein the step S3 specifically comprises:
step S31: superimposing the sinusoidal current reference signal of any phase with the carrier signal and the common mode signal to determine a current reference value of the corresponding phase;
step S32: passing the input current of the corresponding phase and the current reference value of the corresponding phase through a first comparator to generate a first pulse signal, and through a second comparator to generate a second pulse signal;
step S33: passing the sinusoidal current reference signal of the corresponding phase through a third comparator to generate a first sign signal, and through a fourth comparator to generate a second sign signal; and
step S34: multiplying the first pulse signal of the corresponding phase with the first sign signal of the corresponding phase to obtain a gate signal of a positive half-cycle, multiplying the second pulse signal of the corresponding phase with the second sign signal of the corresponding phase to obtain a gate signal of a negative half-cycle, and adding the gate signal of the positive half-cycle and the gate signal of the negative half-cycle to obtain the gate signal of the corresponding phase.

4. The control method according to claim 3, wherein in response to the sinusoidal current reference signal of the corresponding phase being a positive half-wave, a value of the first sign signal is 1, and a value of the second sign signal is 0; in response to the sinusoidal current reference signal of the corresponding phase being a negative half-wave, the value of the first sign signal is 0, and the value of the second sign signal is 1.

5. The control method according to claim 1, wherein the step S2 specifically comprises:
step S21: subtracting the voltage of the first capacitor from the voltage of the second capacitor to obtain a voltage difference; and
step S22: performing PI regulation on the voltage difference to obtain the common mode signal.

6. The control method according to claim 1, wherein the three-phase rectifier comprises a Vienna rectifier.

7. The control method according to claim 2, wherein the step S11 specifically comprises:
step S111: performing abc/dq coordinate transformation on the input voltage of the three-phase rectifier to obtain a q-axis component of the input voltage; and
step S112: subtracting the q-axis component of the input voltage from a 0 voltage reference and then performing proportional-integral (PI) regulation to generate a frequency signal, and integrating the frequency signal to obtain the angle θ.

8. The control method according to claim 2, wherein the step S13 specifically comprises:
step S131: adding the voltage of the first capacitor and the voltage of the second capacitor to obtain a voltage sum signal; and
step S132: subtracting the voltage sum signal from a voltage reference of the DC bus to obtain an error signal, and performing PI regulation on the error signal and then multiplying it with the sinusoidal signal of any phase in the three-phase sinusoidal signals to obtain the sinusoidal current reference signal of the corresponding phase.

9. The control method according to claim 2, wherein the three-phase sinusoidal signals comprise a sinusoidal signal of a first phase, a sinusoidal signal of a second phase and a sinusoidal signal of a third phase;
wherein the sinusoidal signal of the first phase is sinθ;
the sinusoidal signal of the second phase is sin(θ−120°); and
the sinusoidal signal of the third phase is sin(θ+120°).

10. The control method according to claim 7, wherein the step S111 specifically comprises:
performing the abc/dq coordinate transformation by using the angle θ.

11. A power conversion module, comprising:
a three-phase rectifier, wherein the three-phase rectifier comprises a DC bus and a three-phase switch unit, wherein the DC bus is electrically connected to the three-phase switch unit; and
a controller, wherein the controller is configured to:
determine three-phase sinusoidal current reference signals according to an input voltage of the three-phase rectifier, a voltage of a first capacitor of the DC bus, and a voltage of a second capacitor of the DC bus;
determine a common mode signal according to the voltage of the first capacitor and the voltage of the second capacitor; and
determine, according to the sinusoidal current reference signal of any phase in the three-phase sinusoidal current reference signals, a carrier signal, the common mode signal and an input current of a corresponding phase, a gate signal of the corresponding phase, wherein the gate signal of the corresponding phase is configured to control an on or off of the switch unit of the corresponding phase.

12. The power conversion module according to claim 11, wherein the controller comprises:
a reference signal determination module; and wherein
the reference signal determination module is configured to:
determine an angle θ by using a phase-locked loop according to the input voltage of the three-phase rectifier;
determine three-phase sinusoidal signals according to the angle θ; and
determine, according to the voltage of the first capacitor, the voltage of the second capacitor and the sinusoidal signal of any phase in the three-phase sinusoidal signals, the sinusoidal current reference signal of the corresponding phase.

13. The power conversion module according to claim 11, wherein the controller comprises:
a gate signal determination module; and wherein
the gate signal determination module is configured to:
superimpose the sinusoidal current reference signal of any phase with the carrier signal and the common mode signal to determine a current reference value of the corresponding phase;
pass the input current of the corresponding phase and the current reference value of the corresponding phase through a first comparator to generate a first pulse signal, and through a second comparator to generate a second pulse signal;
pass the sinusoidal current reference signal of the corresponding phase through a third comparator to generate a first sign signal, and through a fourth comparator to generate a second sign signal; and
multiply the first pulse signal of the corresponding phase with the first sign signal of the corresponding phase to obtain a gate signal of a positive half-cycle, multiply the second pulse signal of the corresponding phase with the second sign signal of the corresponding phase to obtain a gate signal of a negative half-cycle, and add the gate signal of the positive half-cycle and the gate signal of the negative half-cycle to obtain the gate signal of the corresponding phase.

14. The power conversion module according to claim 13, wherein in response to the sinusoidal current reference signal of the corresponding phase being a positive half-wave, a value of the first sign signal is 1, and a value of the second sign signal is 0; in response to the sinusoidal current reference signal of the corresponding phase being a negative half-wave, the value of the first sign signal is 0, and the value of the second sign signal is 1.

15. The power conversion module according to claim 11, wherein the controller comprises: a common mode signal determination module; and wherein
the common mode signal determination module is configured to:
subtract the voltage of the first capacitor from the voltage of the second capacitor to obtain a voltage difference; and
perform proportional-integral (PI) regulation on the voltage difference to obtain the common mode signal.

16. The power conversion module according to claim 11, wherein the three-phase rectifier comprises a Vienna rectifier.

17. The power conversion module according to claim 12, wherein the reference signal determination module is specifically configured to:
perform abc/dq coordinate transformation on the input voltage of the three-phase rectifier to obtain a q-axis component of the input voltage; and
subtract the q-axis component of the input voltage from a 0 voltage reference and then perform PI regulation to generate a frequency signal, and integrate the frequency signal to obtain the angle θ.

18. The power conversion module according to claim 12, wherein the reference signal determination module is specifically configured to:
add the voltage of the first capacitor and the voltage of the second capacitor to obtain a voltage sum signal; and
subtract the voltage sum signal from a voltage reference of the DC bus to obtain an error signal, and perform PI regulation on the error signal and then multiply it with the sinusoidal signal of any phase in the three-phase sinusoidal signals to obtain the sinusoidal current reference signal of the corresponding phase.

19. The power conversion module according to claim 12, wherein the three-phase sinusoidal signals comprise a sinusoidal signal of a first phase, a sinusoidal signal of a second phase and a sinusoidal signal of a third phase;
wherein the sinusoidal signal of the first phase is sin θ;
the sinusoidal signal of the second phase is sin(θ−120°); and
the sinusoidal signal of the third phase is sin(θ+120°).

20. The power conversion module according to claim 17, wherein the reference signal determination module is specifically configured to:
perform the abc/dq coordinate transformation by using the angle θ.
